(19) United States
(12) Patent Application Publication
(10) Pub. No.: US 2002/0145944 A1
(43) Pub. Date: Oct. 10, 2002

(54) Method and system for managing time zone definitions

(75) Inventor: David Eugene Wright, Cary, NC (US)

Correspondence Address: Gerald R. Woods, IBM Corporation T81/503, P.O. Box 12195, Research Triangle Park, NC, 27709, US

(73) Assignee: International Business Machines Corporation, Armonk, NY (US)

(21) Appl. No.: 09/789,104

(22) Filed: Feb. 20, 2001

(51) Int. Cl. G06F 17/60

(52) U.S. Cl. 368/21; 705/32; 368/10

(57) ABSTRACT

A time zone definition module for a time responsive processing system is disclosed. In response to commands, the module establishes or manipulates time zone definition entries within a database of the system. A user interface of the system enables a user to provide the commands along with any associated data.

### BACKGROUND OF THE INVENTION

1. Field of the Invention

The present invention generally relates to predefined time zone definitions within a database of a time responsive processing system, e.g. a personal computer, a server, a video cassette recorder, a digital video disc player, a programmable alarm clock, etc. The present invention more particularly relates to a user management of predefined and user defined time zone definitions within a database of a time responsive processing system.

2. Description of the Related Art

A time zone definition typically includes a time zone symbol and an offset number from universal time. For example, a time zone definition for Eastern Time would include ET as its time zone symbol and −5 hours as its offset number. A time zone definition can also include rules relating to daylight savings time. For example, a time zone definition for Eastern Time could include rules indicating daylight savings time for the Eastern Time annually starts on the first Sunday of April at 02:00 a.m., and annually stops on the last Sunday of October at 02:00 a.m.

Currently, there exist clock management modules for regulating a clock setting of a time responsive processing system in accordance with a predefined time zone definition. However, the predefined time zone definition is neither accessible nor modifiable by a user of the processing system. Consequently, an upgraded version of the module as supplied by a manufacturer of the module may need to be installed within the processing system whenever a time zone symbol, an offset number, and/or a daylight savings rule (if applicable) of the predefined time zone definition have been officially changed in any manner.

The installation of one or more upgraded versions of a clock management module can be expensive, inconvenient, and/or burdensome for some users. For example, in many cases, the module manufacturer may need weeks or months to develop and distribute an upgraded version of the clock management module after an official change to a time zone definition has been proclaimed. During this development and distribution time, a time responsive processing system may be incorrectly regulating a clock setting of the system. Consequently, the system may be incorrectly storing a time for a future event or future task whereby the system processes the event or the task at an incorrect time. For example, if a time zone definition has not been officially changed within a computer system, a user of the computer system may enter a local time for a future event and the computer system will incorrectly convert the local time to universal time. The event will therefore be untimely processed unless the time zone definition is officially changed prior to the event.

The present invention addresses this problem by facilitating a user management of predefined and user defined time zone definitions.

### SUMMARY OF THE INVENTION

One form of the present invention is a first method for operating a time responsive processing system to manage a time zone definition. The time zone definition is stored. One or more signals indicative of command to manipulate the time zone definition is(are) received. The time zone definition is manipulated in response to the signal(s).

A second form of the present invention is a second method for operating a time responsive processing system to manage a time zone definition. One or more signals indicative of command to establish the time zone definition is(are) received. The time zone definition is stored in response to the signal(s).

A third form of the present invention is a first method for operating a time responsive processing system to regulate a clock setting. One or more signals indicative of command to manipulate a time zone definition is(are) received. The time zone definition is manipulated in response to the signal(s). The clock setting is regulated in accordance with the manipulation of the time zone definition.

A fourth form of the present invention is a second method for operating a time responsive processing system to regulate a clock setting. One or more signals indicative of command to establish a time zone definition is(are) received. The time zone definition is established in response to the signal(s). The clock setting is regulated in accordance with the establishment of the time zone definition.

A fifth form of the present invention is a first computer program product in a computer-readable medium comprising the following means. A means for providing a database including a time zone definition. A means for receiving one or more signals indicative of a command to manipulate the time zone definition. And, a means for manipulating the time zone definition in response the signal(s).

A sixth form of the present invention is a first computer program product in a computer-readable medium comprising the following means. A means for receiving one or more signals indicative of a command to establish a time zone definition. And, a means for providing a database including the time zone definition in response to signal(s).

A seventh form of the present invention is a first computer program product in a computer-readable medium comprising the following means. A means for receiving one or more signals indicative of a command to manipulate a time zone definition. A means for manipulating the time zone definition in response to signal(s). And, a means for regulating a clock setting in accordance with the manipulation of the time zone definition.

An eighth form of the present invention is a first computer program product in a computer-readable medium comprising the following means. A means for receiving one or more signals indicative of a command to establish a time zone definition. A means for establishing the time zone definition in response to signal(s). And, a means for regulating a clock setting in accordance with an establishment of the time zone definition.

A ninth form of the present invention is a system comprising a database and a module. The database includes a time zone definition. The module is operable to manipulate the time zone definition in response to one or more signals indicative of a command to manipulate the time zone definition.

A tenth form of the present invention is a system comprising a module and a memory. The module is operable to manipulate the time zone definition in response to one or more signals indicative of a command to establish the time zone definition. The memory is operable to store the time zone definition.

The foregoing forms and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is block diagram of one embodiment of a computer system in accordance with the present invention;

FIG. 2 is a block diagram of one embodiment of a computer software package of the FIG. 1 computer system in accordance with the present invention;

FIG. 3 illustrates an exemplary display screen of time zone definitions;

FIG. 4 illustrates an exemplary display screen of a daylight savings time schedule; and

FIG. 5 is block diagram of one embodiment of an electronic device in accordance with the present invention.

### DETAILED DESCRIPTION OF THE PRESENTLY PREFERRED EMBODIMENTS

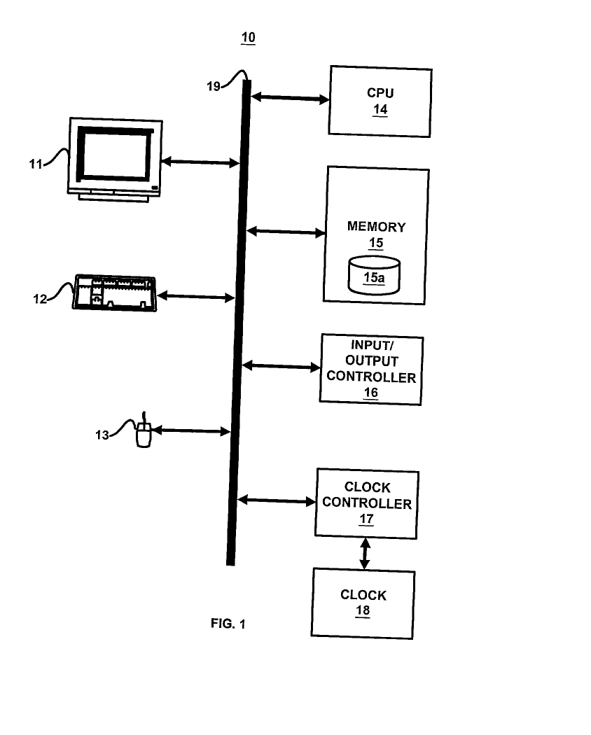

Referring to FIG. 1, a computer system 10 in accordance with the present invention is shown. System 10 comprises a display device in the form of a monitor 11, an input device in the form of keyboard 12, and a pointing device in the form of mouse 13. System 10 further comprises a processor in the form of a central processing unit 14 (hereinafter “CPU 14”), a computer readable medium in the form of a memory 15, an input/output controller 16, a clock controller 17, and a clock 18. Memory 15 includes one or more components like a random access memory (RAM), a read only memory (ROM), a floppy disc, a CD-ROM disc, and a transmission-type media such as a digital or an analog communication link. A bus 18 establishes electrical communication between monitor 11, keyboard 12, mouse 13, CPU 14, memory 15, input/output controller 16, and clock controller 17. Clock controller 17 and clock 18 are in electrical communication.

In one embodiment, system 10 is a personal computer in the form of a desktop computer, a laptop computer, or a workstation. In another embodiment, system 10 is a distributed system. For example, monitor 11, keyboard 12, and mouse 13 are components of a workstation while CPU 14, memory 15, input/output controller 16, clock controller 17 and clock 18 are components of a server. Those having skill in the art will appreciate that system 10 can include additional hardware components known in the art when serving as a personal computer or a distributed system.

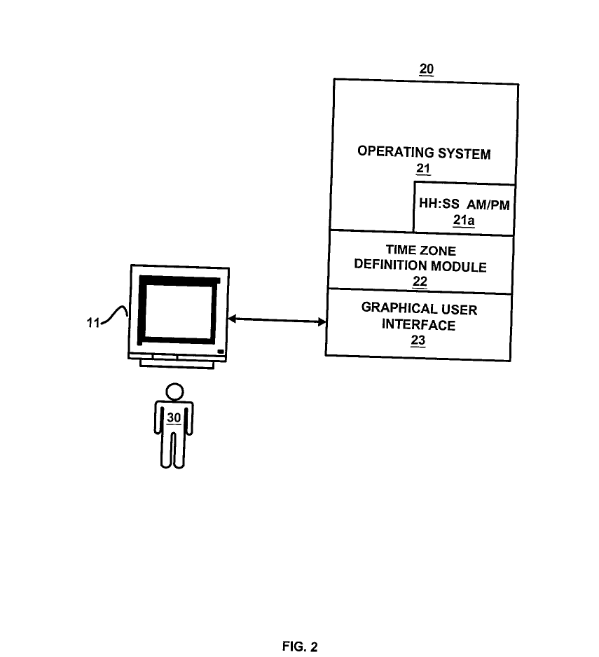

The present invention creates a database 15a within memory 15 of one or more time zone definitions as will be further described in connection with FIG. 2. Each time zone definition includes a time zone symbol, an offset from universal time (hereinafter “UT”), a daylight savings time adjustment (hereinafter “DST ADJ.”) when applicable, a daylight savings time schedule identification (hereinafter “DST Schedule ID”) when applicable, and comments relating to the area covered by the time zone. Those having skill in the art will appreciate that a time zone definition can include other aspects relating to the area covered by the time zone.

Referring to FIG. 2, a computer software package 20 in accordance with the present invention is shown. System 20 is stored within memory 15 (FIG. 1), and includes an operating system 21 such as MS-DOS, a time zone definition module 22, and a user interface in the form of a graphical user interface 23. Operating system 21 conventionally generates a clock setting 21a in response to appropriate signals from clock controller 17 (FIG. 1) and conventionally regulates clock setting 21a in view of an assigned time zone definition of database 15a (FIG. 1). Module 22 establishes and/or manipulates, i.e., modifies, deletes, etc., a time zone definition of database 15a in response to signals indicative of applicable commands. Interface 23 allows a user 30 to provide the commands and any associated data to module 22 via keyboard 12 (FIG. 1) or mouse 13 (FIG. 1) whereby user 30 controls any establishment, and/or any manipulation of a time zone definition of database 15a.

In one embodiment, database 15a including an initial set of time zone definitions is imported into memory 15 (FIG. 1). User 30 can thereafter provide commands to module 22 to manipulate the initial set of time zone definitions and to establish additional time zone definitions of database 15a. In another embodiment, user 30 can provide commands to module 22 to store database 15a including an initial set of time zone definitions within memory 15. User 30 can thereafter provide commands to manipulate the initial set of time zone definitions and commands to establish additional time zone definitions of database 15a.

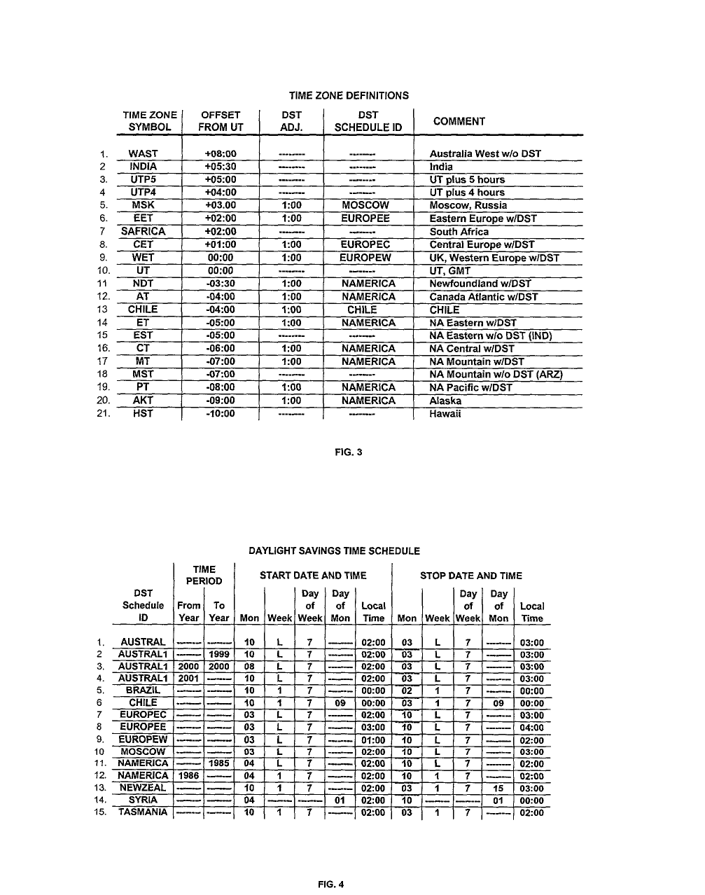

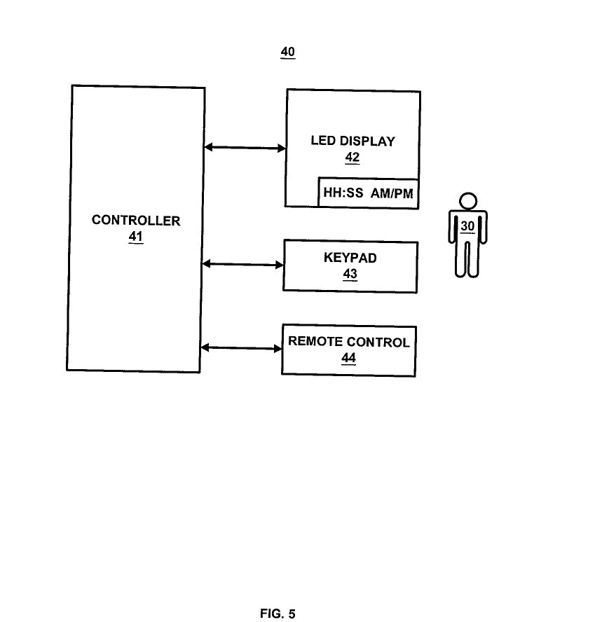

Referring additionally to FIG. 3, an exemplary display screen of time zone definitions of database 15a (FIG. 1) as shown to user 30 via monitor 11 is shown. Each time zone definition entry includes data indicating its time zone symbol, offset from UT, DST ADJ. if applicable, DST schedule ID if applicable, and a pertinent comment. Referring additionally to FIG. 4, an exemplary display screen of a daylight savings time schedule of database 15a (FIG. 1) as shown to user 30 via monitor 11 is shown. Each daylight savings time schedule entry includes data indicating a schedule ID, a time period, a starting date and time, and a stop date and time. For the month (Mon), a name or number can be specified, e.g., April or 04. For the week (Week), a rank and/or a number can be specified. For example, First, Second, Third, Fourth, and Last can be used as ranks. Also by example, numbers 1, 2, 3, 4, and a rank L (last) can be utilized. For the week day (Day of Week), a name or number can be specified, e.g. Monday or 1.

Those having skill in the art will appreciate other display screens for the present invention.

Referring to FIGS. 1-4, the following TABLE 1 is one embodiment of list of commands and corresponding keys of keyboard 11 for manipulating the entries of database 15a as exemplary shown in the FIG. 3 and FIG. 4 display screens.

TABLE 1

| COMMAND | KEY |
|---|---|
| After | A |
| Before | B |
| Copy | C |
| Delete | D |
| Erase | E |
| Insert | I |
| Move | M |
| Repeat | R |

Conventional features such as drop down lists to select commands and “drag and drop” to manipulate entries of a time zone definition and/or corresponding daylight savings time schedule can be utilized in other embodiments of system 10.

Those having skill in the art will appreciate the further advantages for user 30 in being able to establish and manipulate time zone definitions as provided by the present invention. First, user 30 can rename a time zone symbol as shown in FIG. 3 to reflect a personal and meaningful symbol. For example, user 30 can rename time symbol EST under entry 15 to IND to reflect that the time zone definition is only applicable to Indiana.

Second, user 30 can timely update a time zone definition entry or add a new time zone definition entry whenever a change or declaration, permanent or temporary, has been officially decreed. For example, user 30 can annually update entries for time zones having daylight savings times that are annually declared. Also by example, user 30 can update an entry for anomalies such as when Australia started its daylight savings time earlier than normal in 2000 due to the Olympics.

Third, user 30 can establish multiple daylight savings time entries for a single time zone. For example, in 1986, the United States changed the start date of daylight savings time from the “last Sunday in April” to “first Sunday in April”. Thus, as shown in FIG. 4, an entry 11 has a time period ending in 1985, and reflects a start date of the “last Sunday in April” with Mon being 4 for April, Week being L for last, and Day of Week being 7 for Sunday while an entry 12 has a time period of 1986 to perpetuity and a start date of the “first Sunday in April” with Mon being 4 for April, Week being 1 for first, and Day of Week being 7 for Sunday.

Fourth, user 30 can easily impose official restrictions to daylight savings time entries. For example, under START DATE AND TIME, line entry 6 of FIG. 4 lists 10 under Mon, 1 under Week, 7 under Day of Week, and 09 under Day of Mon. This indicates that daylight savings time for line entry 6 starts on the first Sunday on or after October 9. Also by example, under START DATE AND TIME, line entry 14 of FIG. 4 lists 04 under Mon, a blank under Week, a blank under Day of Week, and 01 under Day of Mon. This indicates that daylight savings time for line entry 14 starts on April 1 regardless of what day of the week April 1 is on.

Referring to FIG. 5, an electronic system 40 in accordance with the present invention is shown. System 40 represents a video cassette recorder, a digital video disc player, a programmable alarm clock and other similar time responsive electronic systems. System 40 comprises a controller 41 that is an electronic circuit consisting of one or more components that are assembled as a common unit. Controller 41 may be comprised of digital circuitry, analog circuitry, or both. To implement the principals of the present invention, controller 41 can further include any control clocks, interfaces, signal conditioners, filters, Analog-to-Digital (A/D) converters, Digital-to-Analog (D/A) converters, communication ports, or other types of operators as would occur to those having ordinary skill in the art. In one embodiment, controller 41 includes an integrated processing unit (not shown) operatively coupled to one or more solid-state memory devices (not shown). The memory contains time zone definition module 22 (FIG. 2), and is arranged for regulating a clock setting in accordance with the principals of the module 22 as previously described herein in connection with FIGS. 2-4.

System 40 further comprises a display device in the form of a LED display 42 symbolically displaying a clock setting, an input device in the form of keypad 43, and a pointing device in the form of remote control 44 whereby user 30 can benefit from module 22. In embodiments of system 40 intended to be electrically coupled to a display device like a television, the memory of controller 41 contains a user interface for displaying display screens on the display device.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for operating a time responsive processing system to manage a time zone definition, said method comprising:
storing the time zone definition;
receiving at least one signal indicative of a command to manipulate the time zone definition; and
manipulating the time zone definition in response to said at least one signal.

2. A method for operating a time responsive processing system to manage a time zone definition, said method comprising:
receiving a first set of at least one signal indicative of a command to establish the time zone definition; and
storing the time zone definition in response to said first set of at least one signal.

3. The method of claim 1, further comprising:
receiving a second set of at least one signal indicative of a command to manipulate the time zone definition; and
manipulating the time zone definition in response to said second set of at least one signal.

4. A method for operating a time responsive processing system to regulate a clock setting, said method comprising:
receiving at least one signal indicative of a command to manipulate a time zone definition;
manipulating said time zone definition in response to said at least one signal; and
regulating the clock setting in accordance with said manipulation of the time zone definition.

5. A method for operating a time responsive processing system to regulate a clock setting, said method comprising:
receiving a first set of at least one signal indicative of a first command to establish a time zone definition;
establishing said time zone definition in response to said first set of at least one signal; and
regulating the clock setting in accordance with said establishment of said time zone definition.

6. The method of claim 5, further comprising:
receiving a second set of at least one signal indicative of a second command to manipulate said time zone definition;
manipulating said time zone definition in response to said second set of at least one signal; and
regulating the clock setting in accordance with said manipulation of said time zone definition.

7. A computer program product in a computer-readable medium, said product comprising:
a means for providing a database including a time zone definition;
a means for receiving at least one signal indicative of a command to manipulate said time zone definition; and
a means for manipulating said time zone definition in response said to at least one signal.

8. A computer program product in a computer-readable medium, said product comprising:
a means for receiving a first set of at least one signal indicative of a command to establish a time zone definition; and
a means for providing a database including said time zone definition in response to said first set of at least one signal.

9. The computer program product of claim 8, further comprising:
a means for receiving a second set of at least one signal indicative of a command to manipulate said time zone definition; and
a means for manipulating said time zone definition in response to said second set of at least one signal.

10. A computer program product in a computer-readable medium, said product comprising:
a means for receiving at least one signal indicative of a command to manipulate a time zone definition;
a means for manipulating said time zone definition in response to said at least one signal; and
a means for regulating a clock setting in accordance with a manipulation of said time zone definition.

11. A computer program product in a computer-readable medium, said product comprising:
a means for receiving a first set of at least one signal indicative of a first command to establish a time zone definition;
a means for establishing said time zone definition in response to said first set of at least one signal; and
a means for regulating a clock setting in accordance with an establishment of said time zone definition.

12. The computer program product of claim 11, further comprising:
a means for receiving a second set of at least one signal indicative of a second command to manipulate said time zone definition;
a means for manipulating said time zone definition in response to said second set of at least one signal; and
a means for regulating said clock setting in accordance with a manipulation of said time zone definition.

13. A system, comprising:
a database including a time zone definition; and
a module operable to manipulate said time zone definition in response to at least one signal indicative of a command to manipulate said time zone definition.

14. The system of claim 13, further comprising:
a means for regulating a clock setting in accordance with a manipulation of said time zone definition.

15. The system of claim 13, further comprising:
a means for displaying said command.

16. A system, comprising:
a module operable to establish a time zone definition in response to a first set of at least one signal indicative of a first command to establish said time zone definition; and
a memory operable to store said time zone definition.

17. The system of claim 16, further comprising:
a means for regulating a clock setting in accordance with an establishment of said time zone definition.

18. The system of claim 16, further comprising:
a means for displaying said first command.

19. The system of claim 16, wherein said module is further operable to manipulate said time zone definition in response to a second set of at least one signal indicative of a second command to manipulate said time zone definition.

20. The system of claim 19, further comprising:
a means for regulating a clock setting in accordance with a manipulation of said time zone definition.
